(19) United States
(12) Patent Application Publication
(10) Pub. No.: US 2026/0227810 A1
(43) Pub. Date: Aug. 6, 2026

(54) METHOD FOR DETERMINING WHETHER TO HEAT OR COOL A SURFACE

(71) Applicant: GENTHERM INCORPORATED, Novi, MI (US)

(72) Inventor: Jeremy David SWANSON, Ypsilanti, MI (US)

(21) Appl. No.: 19/152,222

(22) PCT Filed: Jan. 25, 2024
(86) PCT No.: PCT/US2024/012888

§ 371 Date: Jul. 30, 2025

Related U.S. Application Data
(60) Provisional application No. 63/442,250, filed on Jan. 31, 2023.

(51) Int. Cl. G05D 23/19; B60N 2/56; G05B 13/04

(52) U.S. Cl. CPC G05D 23/1902; B60N 2/5685; G05B 13/048

(57) ABSTRACT

A method for determining whether to heat or cool a surface. Hie method comprises determining a first and second heat transfer rate to or from the surface based on, respectively, a first and second temperature applied to the surface. The first temperature is associated with cabin air. The second temperature is associated with a material layer. Tire method comprises estimating a temperature of the surface based on the first and second heat transfer rates. Tire method comprises obtaining a setpoint temperature and comparing the setpoint temperature to the estimated temperature of the surface.

### CROSS-REFERENCE TO RELATED APPLICATIONS

The present application is a national stage application of PCT/US2024/012888, filed on Jan. 25, 2024, which claims priority to U.S. Provisional Application No. 63/442,250 filed on Jan. 31, 2023.

### FIELD

The present disclosure relates to a method for determining whether to heat or cool a surface. The determination is based on heat flow rates relative to the surface.

### BACKGROUND

Typically, conditioning systems apply heating and/or cooling until a setpoint temperature achieves steady state. In one example, the surface of a seat may be heated (e.g., by a resistive heater mat) and/or cooled (e.g., by air) until the surface achieves the setpoint temperature.

In current systems, in order to determine if heating or cooling is required and to what extent thermal effectors should be regulated to achieve the setpoint temperature, the setpoint temperature is typically compared to a current temperature of the article being conditioned, whether the current temperature is based on a direct sensor input, calibrated lookup tables, or the otherwise. However, there are several challenges with comparisons to current temperature by these methods.

Vehicle cabins are subject to complex systems of heat exchange influenced at least by air temperature, occupant body temperature, thermal mass/inertia of vehicle components, radiation, and the like. Thus, while current systems compare a current temperature to a setpoint temperature, it is likely that one or more of the foregoing factors will continue to influence the current temperature. As a result, the system, at least at times, can be constantly operating in a cooling mode and/or a heating mode to “chase” the current temperature with the goal of bringing the steady state temperature to or at least approximately to the setpoint temperature.

It may be appreciated that the resulting operation of heating and/or cooling is an oscillation of temperature above and below the setpoint temperature. Oscillation may be somewhat mitigated by hysteresis, but with such efforts the magnitude of oscillation and the response time of achieving the setpoint temperature cannot both be improved. There is a tradeoff of one for the other and a decision must be made regarding how the two are to be balanced.

In some systems, one or more elements or layers of material may be disposed between a surface to be conditioned and a thermal effector. In this regard, overshooting heating or cooling may be performed to overcome the thermal mass therebetween and cause the desired temperature change in the surface. This operation further instigates the oscillation discussed above.

It would be desirable to provide a method for determining whether to heat or cool a surface.

It would be desirable to provide a method for determining an operation mode of one or more thermal effectors.

It would be desirable to provide a method for estimating the temperature of a surface based on one or a plurality of heat transfers relative to the surface.

It would be desirable to provide a method that accounts for one or a plurality of heat transfer rates in determining whether to heat or cool the surface.

It would be desirable to provide a method that obviates the need for additional calibration efforts related to hysteresis that address thermal effector overshoot.

### SUMMARY

The present disclosure relates to a method that may address at least some of the needs discussed above. The method may comprise determining a first heat transfer rate to or from the surface based on a first temperature applied thereto. The first temperature may be associated with cabin air. The method may comprise determining a second heat transfer rate to or from the surface based on a second temperature applied thereto. The second temperature may be associated with a material layer. The material layer may be below the surface. The material layer may be adjacent to the surface.

The method may comprise estimating a temperature of the surface based on the first heat transfer rate and the second heat transfer rate. The method may comprise obtaining a setpoint temperature. The method may comprise comparing the setpoint temperature to the estimated temperature of the surface.

The method may comprise determining a third heat transfer rate to or from the surface based on a third temperature applied thereto. The third temperature may be associated with an occupant. The estimated temperature of the surface may be further based on the third heat transfer rate.

The method may comprise determining a fourth heat transfer rate to or from the surface based on a fourth temperature applied thereto. The fourth temperature may be associated with thermal radiation. The estimated temperature of the surface may be further based on the fourth heat transfer rate.

The method may comprise determining an occupancy status. If the surface is occupied, at least the first and third heat transfer rates may be employed to estimate the temperature of the surface. If the surface is unoccupied, at least the first heat transfer rate may be employed to estimate the temperature of the surface. The occupancy status may determine the magnitude of an effect of the thermal radiation.

The estimated temperature of the surface may be predictive of the effect of the first, second, third, or fourth heat transfer rates, or any combination thereof, on the surface during a time of a program cycle.

The estimated temperature of the surface may be further based on the setpoint temperature at steady state.

At or around the setpoint temperature, at least one thermal effector may not be operational and/or the temperature of the surface may be estimated without consideration of a heat transfer rate relative to the at least one thermal effector.

The setpoint temperature may be selected by the occupant and/or an autonomous conditioning system. The setpoint temperature may be received by a human-machine interface from the occupant.

At least one thermal effector may influence heating or cooling of the surface.

If the estimated temperature of the surface is generally equal to the setpoint temperature, an operation mode of the at least one thermal effector may be set to OFF.

If the estimated temperature of the surface is less than the setpoint temperature, the at least one thermal effector may operate in a heating mode.

If the estimated temperature of the surface is greater than the setpoint temperature, the at least one thermal effector may operate in a cooling mode.

The method may further comprise controlling the at least one thermal effector by regulating power to the thermal effector (e.g., by pulse width modulation duty cycle, constant current control, or the like) and/or controlling a speed of a blower to achieve the setpoint temperature.

The present disclosure relates to a system that may address at least some of the needs discussed above. The system may perform the method described herein.

The surface may be on a vehicle component. The vehicle component may include a steering wheel, a gear shifter, a seat, a headrest, a door panel, an instrument panel, a headliner, a center console, a leg panel, a floor, or any combination thereof.

The at least one thermal effector may include two or more thermal effectors that cooperate in thermally influencing the surface.

The thermal effector may include a resistance element, a thermoelectric device, or both.

The at least one thermal effector may conductively thermally communicate with the surface.

The at least one thermal effector may act upon an airstream that convectively thermally communicates with the surface or convectively thermally communicates with an element that conductively communicates with the surface.

The system may comprise a containment device located within the vehicle component. The airstream may flow into the containment device.

The present disclosure relates to a vehicle that may address at least some of the needs discussed above. The vehicle may comprise the system described herein.

### BRIEF DESCRIPTIONS OF THE DRAWINGS

FIG. 1 illustrates a vehicle component.

FIG. 2 illustrates a vehicle component.

FIG. 3 is a flowchart of the method of the present teachings.

### DESCRIPTION

The present disclosure provides for a method for determining whether to heat or cool a surface. The present disclosure provides for a method for determining the operation mode of one or more thermal effectors. The thermal effectors may have an ON/OFF operation mode. In the ON mode, the thermal effectors may provide heating and/or cooling.

The surface may exchange heat with one or more material layers, an occupant, cabin air, radiative heat sources, the like, or any combination thereof. The determination of the operation mode, heating, and/or cooling may be based on one or more heat transfer rates relative to the surface.

By determining one or more heat transfer rates relative to the surface at steady state, the conditioning system may be operated predictively rather than reactively. Steady state, as referred to herein, may mean the maintenance of a temperature (e.g., the setpoint temperature) over time (e.g., 5 minutes or less, 1 minute or less, 30 seconds or less, 10 seconds or less, 5 seconds or less, or even 1 second or less).

By way of example, a seat surface setpoint temperature may be 30° C. and increased by an occupant selection to 32° C. Without considering other heat transfers into the surface, conventional conditioning systems may operate a thermal effector to heat the surface to 32° C. and may overshoot its heating operation in order to overcome a thermal mass between a thermal effector and the surface. However, by the method and system of the present disclosure, heating, in this example, may be provided to a lesser degree relative to conventional systems operating under the same circumstances or even not at all, while achieving the same overall effect.

For instance, drawing from the same example, if the cabin air temperature is 35° C. and an occupant's body temperature is about 36° C., then by the present method, it may be determined that a thermal effector need not be operated in order to achieve the 32° C. setpoint (e.g., during at least one program cycle), but rather the heat transfer from the air and the occupant to the surface may be sufficient to achieve the setpoint.

Moreover, to the extent that any heat may be provided by a thermal effector, it may be provided by a lesser degree relative to conventional systems operating under the same or similar circumstances, with the understanding that cabin air, occupants, thermal radiation, the thermal effector, and other elements thermally communicating with the surface work cooperatively to exchange heat with the surface.

The present disclosure contemplates that the same concepts as provided in the above example may be applicable to cooling operations.

The method may comprise obtaining an occupancy status of a seat. The occupancy status may characterize whether an occupant is or is not present in a seat. The occupancy status may be provided by the vehicle using existing sensors, such as occupancy sensors for the operation of air bags. The occupancy status may be relevant to thermal resistances, surface areas over which elements thermally communicate with a surface, what elements (e.g., cabin air, an occupant, thermal radiation) are thermally communicating with the seat, or any combination thereof.

A seat that is occupied may result in compression of a trim layer, one or more material layers, a fluid distribution device, or any combination thereof. Compression may influence the thermal resistances discussed herein, as the thickness through which heat travels may be different in a compressed seat versus an uncompressed seat. Compression may influence the surface area through which heat exchange occurs, as discussed herein.

A seat that is unoccupied may indicate that a vehicle component thermally communicates with cabin air, one or more material layers, thermal radiation, or any combination thereof.

A seat that is occupied may indicate that a vehicle component thermally communicates with an occupant, cabin air, one or more material layers, thermal radiation, or any combination thereof. A surface of an occupied seat may include one or more portions, typically two or more portions, characterized by surface areas over which heat transfer occurs with an aforementioned element.

Thermal radiation may originate from one or more components within the vehicle, the sun, or the like. Thermal radiation may travel through one or more components within the vehicle and ultimately be directed to the surface of the seat. For instance, the sun, power units (e.g., internal combustion engines, battery cells, or the like), or both may heat one or more components within the vehicle and cause thermal radiation to be directed to the surface of the seat.

A vehicle component that is thermally influenced by an occupant may have a surface area that is not contacted by the occupant. This surface area may be thermally influenced by cabin air and/or thermal radiation. By way of example, a seat with an occupant situated thereon may have a surface area between the occupant's thighs and/or around the thighs and/or buttocks of the occupant that is thermally influenced by cabin air and/or thermal radiation.

Surface area may be relevant to the determination of heat transfer rates relative to the surface. Thus, each element thermally influencing the surface may be associated with its own heat transfer rates based at least in part on the temperatures thereof and the surface area over which they thermally influence the surface.

The system described herein may comprise an occupancy sensor. The occupancy sensor may function to determine the occupancy status of a seat. A non-limiting example of an occupancy sensor is described in U.S. Pat. No. 7,205,902 B2 (describing a sensor used in the activation of an air bag), incorporated herein by reference in its entirety for all purposes. Non-limiting examples of occupancy sensors that detect occupants' contact with vehicle components (e.g., steering wheels or gear shifters) are described in U.S. Pat. No. 9,266,454 B2 (describing, e.g., capacitance sensors, pressure sensors, etc.), incorporated herein by reference in its entirety for all purposes.

The method may comprise determining one or more heat transfer rates relative to the trim layer. The heat transfer rates may include the heat transfer rate between cabin air and the trim layer (\dot{Q}_{cab}), the heat transfer rate between an occupant and the trim layer (\dot{Q}_{occ}), the heat transfer rate between one or more material layers and the trim layer (\dot{Q}ₘₐₜ), and the heat transfer rate between any number of other elements (e.g., thermal radiation sources) and the trim layer (\dot{Q}ₒₜₕₑᵣ), or any combination thereof.

The heat transfer rates may be determined based on the temperature of the trim layer (Tₜᵣᵢₘ); the temperature of the element thermally communicating with the trim layer including the cabin air (T_{cab}), the occupant (Tₛₖᵢₙ), one or more material layers (Tₘₐₜ), as well as other elements contemplated by the present teachings such as elements that direct thermal radiation toward the surface; the area over which heat transfer occurs (A); the thermal resistance (R); or any combination thereof. In regard to the thermal resistance between an occupant and a surface, the thermal resistances of clothing and/or skin (R_{clo}, Rₛₖᵢₙ) may be considered. Formulae for determining these heat transfer rates are provided hereunder.

$${\dot{Q}}_{c a b} = \frac{( {T}_{c a b} - {T}_{trim} ) \times A}{R} \qquad Eq . A$$

$${\dot{Q}}_{o c c} = \frac{( {T}_{s k i n} - {T}_{trim} ) \times A}{( {R}_{c l o} + {R}_{s k i n} )} \qquad Eq . B$$

$${\dot{Q}}_{m a t} = \frac{( {T}_{m a t} - {T}_{trim} ) \times A}{R} \qquad Eq . C$$

The heat transfer rate between one or more thermal effectors and a surface and/or between one or more thermal effectors and a material layer (e.g., spacer layer) may be ignored. The surface may be assumed to be at steady state and thus the thermal effectors may be non-operational while the surface is at steady state.

The temperatures of the trim layer, cabin air, occupant's skin, and material layer may be determined as described herein.

By accounting for all heat transfer rates relative to a surface, such as described in Eqs. A-C, the temperature of the surface influenced by the heat transfers may be estimated. The effect of the heat transfers may be assumed to occur on a surface that is at steady state.

The method may comprise estimating the temperature of the trim layer (Tₑₛₜ) influenced by the heat transfer rates relative to the trim layer. The temperature of the trim layer may be estimated based on the sum of the heat transfer rates relative to the trim layer (e.g., \dot{Q}_{cab}, \dot{Q}_{occ}, \dot{Q}ₘₐₜ, \dot{Q}ₒₜₕₑᵣ, or any combination thereof), the program cycle time (Δt) (e.g., 1 second or less, 50 milliseconds or less, 30 milliseconds or less, or even 10 milliseconds or less), the thermal capacitance (C), the setpoint temperature (Tₛₑₜ) at steady state, or any combination thereof.

$${T}_{e s t} = {T}_{s e t} + \frac{Σ \dot{Q}}{c} \times Δ t \qquad Eq . D$$

Thermal resistances, thermal capacitances, surface areas, and program cycle times may be referred to herein as pre-determined values. That is, these values may be known and/or non-transient. The values may be defined for different vehicle makes, models, model years, trim levels, or any combination thereof, understanding that different vehicle builds employ different materials with associated thicknesses and different stack-ups of materials. The values may be defined for different system states (e.g., an occupied seat and an unoccupied seat).

The program cycle time may refer to the time in which the above calculations are performed, including any gaps in time between a first temperature estimation and a second temperature estimation. The program cycle time may be provided by a timer.

The setpoint temperature of the trim layer at steady state may be employed. Moreover, the heat transfer rates relative to thermal effectors may not be accounted for in the estimated temperature of the trim layer. Thus, it is estimated what the temperature of the trim layer will be in a given program cycle based on the heat transfer rates relative to the trim layer with a starting temperature of the trim layer assumed as the setpoint temperature. In this regard, it may be determined if one or more thermal effectors operate in a heating mode, in a cooling mode, or do not operate at all to achieve the setpoint temperature.

One or more thermal effectors may operate in relation to the estimated temperature compared to the setpoint temperature.

In one aspect, if the estimated temperature of the trim layer is greater than the setpoint temperature, one or more thermal effectors may operate in a cooling mode. Thus, the operation of the thermal effectors may counteract the heat transfer rates not attributable to the thermal effectors.

In another aspect, if the estimated temperature of the trim layer is less than the setpoint temperature, one or more thermal effectors may operate in a heating mode. Thus, the operation of the thermal effectors may counteract the heat transfer rates not attributable to the thermal effectors.

In another aspect, if the estimated temperature of the trim layer is equal to or generally equal to the setpoint temperature, one or more thermal effectors may not operate. Thus, the setpoint temperature may be maintained.

It is contemplated by the present teachings that one or more thermal effectors may not operate even if the estimated trim layer temperature is not exactly equal to the setpoint temperature. That is, the operation mode may be governed by a tolerance. The tolerance may be a temperature differential, between the estimated temperature of the trim layer and the setpoint temperature. The tolerance may be about ±2° C. or less, ±1.5° C. or less, ±1° C. or less, or even ±0.5° C. or less. Temperature differentials within the tolerance may not be readily perceptible to an occupant. In this regard, energy savings may be realized by not operating thermal effectors within the tolerance.

Thermal effector regulation may be determined as described in U.S. Provisional Application No. 63/337,645 (entitled “Method for Controlling a Conductive or Convective Effector”), incorporated herein by reference in its entirety for all purposes.

The heat transfer rate relative to one or more thermal effectors that is required to achieve the setpoint temperature may be determined. Based on the required heat transfer rate relative to one or more thermal effectors, the temperatures of the one or more thermal effectors may be determined according to the teachings herein.

With a known required heat transfer rate, the form of Eqs. A-C may be employed where the temperature of the one or more thermal effectors is the unknown value to be determined by the required heat transfer rate, the surface area over which heat transfer occurs, and the thermal resistance. The other temperature in the aforementioned equations may be that of an element the one or more thermal effectors thermally communicate with. Typically, one or more material layers may be present between the one or more thermal effectors and the surface.

Where one or more material layers are disposed between a thermal effector and the trim layer, the equations taught herein may be employed progressively for each layer in the system until ultimately the required temperature of the thermal effector is determined. For instance, one iteration of calculation may be performed to determine a temperature of a material layer, and then another iteration of calculation may be performed to determine a required temperature of the one or more thermal effectors.

The thermal effectors may be regulated by a duty cycle (e.g., pulse width modulation, constant current control, or the like).

The present disclosure provides for a conditioning system that performs the method described herein.

The surface may be any exposed surface of a vehicle component. The vehicle component and the exposed surface thereof may be located within the cabin of the vehicle. The surface may be referred to herein alternatively as a trim layer. That is, the exposed, visible surfaces of the vehicle (e.g., leather, faux leather, vinyl, or fabric) commonly contacted and/or seated upon by occupants. The vehicle component may include any component contacted by an occupant.

The vehicle component comprising the surface may include a seat. The seat may comprise a back portion, one or more back bolsters, a seat portion, one or more seat bolsters, a headrest, or any combination thereof.

Vehicle, as referred to herein, may mean any automobile, recreational vehicle, sea vessel, air vessel, the like, or any combination thereof. While the present disclosure discusses a vehicle seat, the teachings herein may be adapted for any thermally conditioned article. By way of example, the present teachings may be applied to furniture (e.g., chairs and beds), buildings, the like, or any combination thereof.

In one aspect, the surface may be thermally influenced by conduction. By way of example, heat generated by a resistive heater mat may be conducted directly, or indirectly through one or more material layers, to the surface.

In another aspect, the surface may be thermally influenced by convection. Convective air may be drawn into the surface (i.e., pull mode) and/or expelled from the surface (i.e., push mode). Convective air may travel through one or more material layers located underneath the surface. Convective air may influence the temperature of the surface, provide heat to an occupant, draw heat away from an occupant, draw moisture away from an occupant, or any combination thereof.

It is understood that convection may also influence conduction. That is, convective air may thermally influence elements and/or layers that conductively thermally communicate with the surface.

The vehicle component may comprise one or more thermal effectors, one or more material layers, one or more fluid distribution devices, a trim layer, or any combination thereof.

In one aspect, the vehicle component (e.g., a seat) may comprise one or more material layers disposed between one or more thermal effectors and the trim layer.

In another aspect, the vehicle component (e.g., a seat) may comprise one or more material layers disposed between one or more fluid distribution devices and the trim layer. In regard to convection, one or more of the material layers may comprise channels and/or porosity through which air may flow. Channels may extend from one side of the material layer to an opposing side of the material layer (e.g., the top side to the bottom side). Channels may extend generally straight between the first and second sides. Channels may have at least one dimension that is from about 0.1 mm to about 2 cm. Porosity may be defined by open-cell foam, non-woven fabric, woven fabric, or the like. The porosity may extend at least partially from one side of the material layer to an opposing side of the material layer (e.g., the top side to the bottom side). The porosity may form a tortuous path for airflow.

The material layer may function to protect the fluid distribution device and/or thermal effector, provide comfort to occupants, regulate the heat transfer rate through the material layer by virtue of the material and thickness of the material layer, facilitate and/or distribute air flow therethrough, or any combination thereof. The material layer may comprise one or more woven fabrics, non-woven fabrics, films, leathers, foams, meshes, air pockets, or any combination thereof.

Although the present disclosure discusses an exemplary arrangement of one material layer (e.g., a spacer layer) disposed under the trim layer, other layer arrangements are contemplated by the present disclosure. The other layer arrangements may include more than one material layer or even elimination of the material layer.

The temperature of the surface may be regulated by one or more thermal effectors (“effectors”). The thermal effectors may thermally communicate with a surface and/or one or more material layers via conduction and/or convection.

The thermal effectors may include one or more resistive heaters. The resistive heater may generate heat that is ultimately conducted to a surface. A non-limiting example of a resistive heater is described in U.S. Pat. No. 9,657,963 B2 (describing a heater mat), incorporated herein by reference for all purposes.

The thermal effectors may include one or more thermoelectric devices. The thermoelectric device may function in a heating mode and/or a cooling mode. A non-limiting example of a thermoelectric device is described in U.S. Pat. No. 9,857,107 B2, incorporated herein by reference for all purposes.

The thermal effectors may be located within or proximate to a vehicle component. One or more material layers may be located between a thermal effector and a trim layer.

Heating and/or cooling may utilize a fluid medium (e.g., air) that transports heat to and/or from an occupant, vehicle component, or both. The thermal effectors may thermally communicate with the fluid medium. The fluid medium may be delivered to a fluid distribution device. The fluid distribution device may be located within a vehicle component. One or more material layers may be located between the fluid distribution device and a trim layer.

The fluid medium may be moved by one or more blowers. Non-limiting examples of blowers are described in International Publication No. WO 2008/115831 A1 and U.S. Pat. No. 9,121,414 B2, incorporated herein by reference for all purposes. The blowers may operate in a push mode, whereby the fluid medium is pushed toward the surface. The blowers may operate in a pull mode, whereby the fluid medium is pulled from the surface. The blowers may include a radial blower, an axial blower, or both.

One or more conduits may extend between the blower and the fluid distribution device. The conduits may carry a fluid medium therebetween. One or more thermal effectors may be located within one or more conduits, blowers, or both.

The thermal effectors may thermally communicate with one or more heat exchangers. The heat exchangers may be fabricated from a thermally conductive material (e.g., thermal conductivity of about 100 W/(m·K) or more, more preferably about 200 W/(m·K) or more, or even more preferably about 300 W/(m·K) or more). The heat exchanger may be adapted with a surface area over which an airstream travels. To this end, the heat exchanger may include a plurality of fins or corrugations, although any other suitable shape is contemplated by the present teachings. Non-limiting examples of suitable heat exchangers are described in U.S. Pat. Nos. 7,178,344 B2 and 8,143,554 B2, incorporated herein by reference for all purposes.

The fluid distribution device may function to distribute air across a surface area (in push mode) or collect air from across a surface area (in pull mode). The fluid distribution device may comprise one or more channels and/or an enclosure through which air flows. The fluid distribution device may define an inner volume through which air flows.

The material layer may define at least a portion of the fluid distribution device. For example, a layer of a seat may comprise one or more channels formed therein, the channels being exposed on a surface of said layer. The material layer may be disposed onto the layer and over the one or more channels to define an enclosed volume of the one or more channels through which air may travel.

The fluid distribution device may be rigid, flexible, or both. The fluid distribution device may comprise a bag. The fluid distribution device may comprise one or more portions that are air permeable. The one or more air permeable portions may be oriented toward the direction of the occupant. The fluid distribution device may comprise one or more portions that are air impermeable.

The fluid distribution device may comprise a spacer material. The spacer material may at least partially prevent compression of the seat from pinching opposing surfaces of the fluid distribution device and restricting airflow. In regard to flexible fluid distribution devices, the spacer material may maintain a spacing between opposing surfaces of the fluid distribution device. The spacer material may comprise mesh, foam, woven textile, non-woven textile, or any combination thereof. The spacer material may be air permeable.

The setpoint temperature and/or operation mode of the thermal effectors may be determined by an occupant's actuation of one or more knobs, buttons, dials, toggles, switches, the like, or any combination thereof (i.e., a human-machine interface).

The setpoint temperature and/or operation mode of the thermal effectors may be determined by an autonomous control system. These systems may account for one or more sensor inputs and regulate the setpoints autonomously via one or more controllers.

Any determination, calculation, estimation, storage, transmission, and/or obtaining step recited herein may be performed by one or more controllers. The controllers may include one or more dedicated effector controllers, vehicle controllers, or both. Calculations and dynamic estimations may be performed by one controller or distributed between a plurality of controllers. Any pre-determined values or inputs may be stored locally on and/or remote from the controllers. Any inputs that are calculated or estimated from prior program cycles may be stored locally on and/or remote from the controllers. Any inputs from one or more prior program cycles may be stored temporarily on and/or remote from the controllers. Any calculated or estimated inputs from one or more prior program cycles may be replaced or updated by calculated or estimated inputs from a current program cycle. The foregoing is applicable to all embodiments.

Any communication or transmission between different controllers, sensors, and/or other devices may be via a local interconnect network (LIN) bus. Communications or transmissions may occur from a sensor to a controller or from a controller to another controller. By way of example but not limitation, an occupancy sensor may transmit an occupancy status to a vehicle controller, and then the vehicle controller may transmit the occupancy signal to a dedicated effector controller. The foregoing is applicable to all embodiments.

The method may comprise dynamically estimating the temperature of the trim layer, the temperature of the cabin air, the temperature of an occupant's skin, the temperature of a material layer (e.g., spacer layer), or any combination thereof. These temperatures may be employed in the heat transfer rate determination and trim layer temperature estimation discussed above.

Estimation, as referred to herein, may mean the calculation of a parameter understanding that the result of such calculation may not exactly correspond with the actual value (e.g., temperature of a surface). Thus, the result of such calculation may be an estimate of the actual value. The system and method of the present disclosure may provide an estimate that deviates about 10% or less, more preferably 5% or less, or even more preferably 1% or less from the actual value.

The temperature of any element in the system may be determined by the following equation in which the estimated temperature of the subject element (Tₑₛₜ) may be estimated from the prior temperature of the subject element (T₍ₙ₋₁₎), the sum of the heat transfer rates relative to the element (Σ\dot{Q}), the thermal capacitance (C), the cycle time (Δt), or any combination thereof.

$${T}_{e s t} = {T}_{( n - 1 )} + \frac{Σ \dot{Q}}{c} \times Δ t \qquad Eq . E$$

The heat transfer rates employed in Eq. E may be determined by the following equation in which the heat transfer rate relative to the subject element (\dot{Q}) may be determined from the temperature of the subject element (T_{A}), the temperature of the element thermally communicating with the subject element (T_{B}), the area through which heat transfer occurs (A), and the thermal resistance (R).

$$\dot{Q} = \frac{( {T}_{B} - {T}_{A} ) \times A}{R} \qquad Eq . F$$

It is understood that heat transfer rate calculations and temperature estimations as provided in Eq. E and Eq. F may be performed progressively for each layer in the system until ultimately the temperature of the trim layer is estimated. By way of example, the temperature of a material layer may be determined by calculating the heat transfer rates relative to the material layer and on the basis of the estimated temperature of the material layer, a heat transfer rate between the material layer and the trim layer may be determined. The temperature of the trim layer may be based at least in part on the heat transfer rate between the material layer and the trim layer, as well as other heat transfer rates discussed herein.

At start-up of the vehicle, the temperatures of the trim layer, cabin air, and material layer may be assumed equal to the temperature sensed by a local sensor. That is, at start-up it may be assumed that these elements have been soaking at the temperature of their surrounding environment, whereby the temperature of the surrounding environment may be determined by a local sensor. The local sensor may be an existing sensor in the vehicle.

The temperature sensor may include a negative temperature coefficient (NTC) resistor, a resistance temperature detector (RTD), a thermocouple, a semiconductor-type sensor, or any combination thereof.

The method of the present disclosure may not require temperature sensors to be located on or proximate to a surface being thermally conditioned. That is, the temperature of a surface may be dynamically estimated as described herein.

The temperature of an occupant may be sensed and/or assumed to be a temperature within the normal physiological range for body temperature (e.g., about 36° C. to 37° C.).

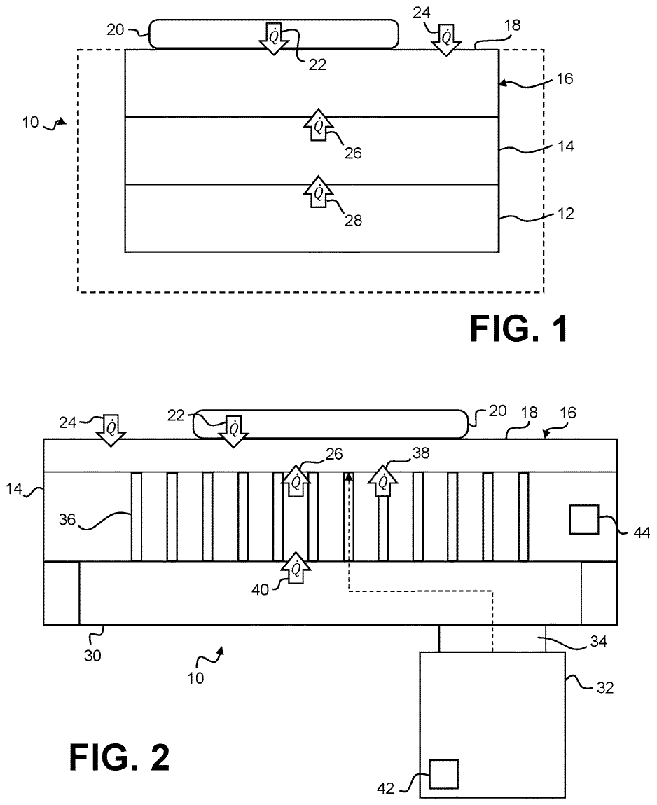

FIG. 1 illustrates a vehicle component 10 (e.g., a seat). The vehicle component 10 comprises a layered build of a thermal effector 12 (e.g., resistance heater mat), a material layer 14, and a trim layer 16. A portion of a surface 18 of the trim layer 16 is contacted by an occupant 20. Another portion of the surface 18 is exposed to the cabin environment.

The trim layer 16 is thermally regulated by the thermal effector 12. Heat generated by the thermal effector 12 is ultimately conducted to the trim layer 16. As illustrated, a material layer 14 (e.g., spacer layer) is disposed between the thermal effector 12 and the trim layer 16. The present teachings contemplate more than one material layer 14 disposed therebetween, as well as no material layer 14 disposed therebetween.

The trim layer 16 is thermally influenced by a heat transfer rate 22 relative to the occupant 20, a heat transfer rate 24 relative to the cabin air, and a heat transfer rate 26 relative to the material layer 14. A heat transfer rate 28 relative to the thermal effector 12 acts upon the material layer 14 as well. However, by the method of the present teachings, the heat transfer rate 28 may not be considered in the determination of the operating mode of the thermal effector 12 as well as whether the thermal effector 12 functions to heat or cool the surface.

It is understood that the directions of heat transfers depicted in FIG. 1 are illustrative and not restrictive. Depending on the relative temperatures of two thermally communicating mediums, the direction of heat transfer may be in a direction opposing the depicted direction.

As shown in FIG. 1, heat transfers occur conductively between the trim layer 16 and the occupant 20, between the trim layer 16 and the material layer 14, and between the material layer 14 and the thermal effector 12.

FIG. 2 illustrates a vehicle component 10 (e.g., a seat). The vehicle component 10 comprises a layered build of a fluid distribution device 30, a material layer 14, and a trim layer 16. A blower 32 is located on an underside of the vehicle component 10 and is fluidly connected to the fluid distribution device 30, with a conduit 34 disposed therebetween. The present teachings contemplate that the conduit 34 may or may not be present and if not present, the blower 32 may be directly connected to the fluid distribution device 30. Moreover, the conduit 34 may be extended or shortened in length to suit various positions of the blower 32 relative to the vehicle component 10. In this regard, the conduit 34 may comprise one or more bends.

Air from the underside of the vehicle component 10 may be drawn into an inlet of the blower 32 and expelled through an outlet of the blower 32, ultimately entering and filling the fluid distribution device 30. The air travels through a plurality of channels 36 formed in the material layer 14 to the trim layer 16, thus conditioning an occupant 20 contacting the trim layer 16. It is contemplated that the material may or may not include porosity in addition to the channels 36 or to the exclusion of the channels 36. The present teachings contemplate no channels or porosity present in the material layer 14.

The depicted manner of airflow may be referred to as push mode (i.e., air pushed by the blower 32 toward the occupant 20), one exemplary path of which is illustrated proceeding through the vehicle component 10 in broken lines. The present teachings contemplate operation in the opposite manner, referred to as pull mode (i.e., air pulled away from the occupant 20 by the blower 32). It is understood that air may travel through all of the depicted channels 36 and one exemplary path is shown for illustrative purposes.

The trim layer 16 thermally communicates with the occupant 20 and/or the cabin air proximate to the trim layer 16. In one aspect, a vehicle component 10 may be unoccupied, and in this regard the trim layer 16 only thermally communicates with the cabin air. In another aspect, a vehicle component 10 may be occupied, and in this regard a portion of the trim layer 16 thermally communicates with the occupant 20 while another portion of the trim layer 16 thermally communicates with the cabin air.

Heat transfer rates between the trim layer 16 are illustrated and include a heat transfer rate 22 relative to the occupant 20, a heat transfer rate 24 relative to the cabin air, a heat transfer rate 26 relative to the material layer 14, and a heat transfer rate 38 relative to an airflow through the channels 36. Moreover, the fluid distribution device 30 and the material layer 14 thermally communicate with each other, thus a heat transfer rate 40 relative to the fluid distribution device 30 is present.

It is understood that the directions of heat transfers depicted in FIG. 2 are illustrative and not restrictive. Depending on the relative temperatures of two thermally communicating mediums, the direction of heat transfer may be in a direction opposing the depicted direction.

The present method provides for a dynamic estimation of the temperature of a thermal medium (e.g., a trim layer, a spacer layer, a fluid distribution device, etc.) based upon one or more calculated heat transfer rates to and/or from the thermal medium. Ultimately the temperature of a surface 18 contacted by an occupant 20 may be dynamically estimated and utilized in the control of the blower 32. In this regard, a temperature sensor 42 and optionally a relative humidity sensor 44 may be employed. As illustrated, the temperature sensor 42 is located in the blower 32 and the relative humidity sensor 44 is located in the spacer layer 14, however, the present teachings contemplate that the sensors may be located anywhere that is practicable in view of the present teachings.

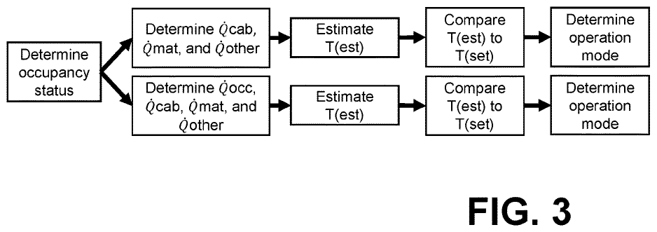

FIG. 3 is a flowchart of the method according to the present teachings.

The occupancy status is determined to inform the system which heat transfer rates are acting upon the trim layer. If the vehicle component is unoccupied, the heat transfer rates include those relative to the cabin air, the material layer, and possibly other sources. If the vehicle component is occupied, the heat transfer rates include those relative to an occupant, cabin air, the material layer, and possibly other sources. The present teachings contemplate that the heat transfer rate relative to cabin air may be omitted if the seat is occupied.

The aforementioned heat transfer rates are determined. The calculations of heat transfer rates are based on the temperatures of the two thermally communicating elements, the surface area over which heat transfer occurs, and the thermal resistance associated with the heat transfer. The temperatures of the mediums may be determined by a dynamic estimation or a local sensor, as described herein.

The temperature of the trim layer is estimated based on the heat transfer rates determined previously and further on the thermal capacitance associated with the heat transfer and the cycle time over which the heat transfer occurs.

The temperature of the trim layer is compared with the setpoint temperature and then the operation mode of the thermal effectors is determined based on the comparison, as taught herein.

It is understood that the above description is intended to be illustrative and not restrictive. The explanations and illustrations presented herein are intended to acquaint others skilled in the art with the invention, its principles, and its practical application. Many embodiments as well as many applications besides the examples provided will be apparent to those of skill in the art upon reading the above description.

The scope of the invention should, therefore, be determined not with reference to the above description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

The method may comprise one or more of the steps recited herein. Some of the steps may be duplicated, removed, rearranged relative to other steps, combined into one or more steps, separated into two or more steps, or any combination thereof.

The flow charts described herein do not imply a fixed order to the steps, and embodiments of the present invention may be practiced in any order that is practicable, unless otherwise specified herein.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Unless otherwise stated, all ranges include both endpoints and all numbers between the endpoints.

The use of “about” or “approximately” in connection with a range applies to both ends of the range. Thus, “about 20 to 30” is intended to cover “about 20 to about 30”, inclusive of at least the specified endpoints.

The term “consisting essentially of” to describe a combination shall include the elements, components, or steps identified, and such other elements, components, or steps that do not materially affect the basic and novel characteristics of the combination. The use of the terms “comprising” or “including” to describe combinations of elements, components, or steps herein also contemplates embodiments that consist essentially of the elements, components, or steps.

### REFERENCE NUMERALS

10 Vehicle component
12 Thermal effector
14 Material layer
16 Trim layer
18 Surface
20 Occupant
22 Heat transfer rate, relative to occupant
24 Heat transfer rate, relative to cabin air
26 Heat transfer rate, relative to material layer
28 Heat transfer rate, relative to thermal effector
30 Fluid distribution device
32 Blower
34 Conduit
36 Channel
38 Heat transfer rate, relative to airflow
40 Heat transfer rate, relative to fluid distribution device
42 Temperature sensor
44 Relative humidity sensor

What is claimed is:

1. A method for determining whether to heat or cool a surface, the method comprising:
determining a first heat transfer rate to or from the surface based on a first temperature applied thereto, the first temperature being associated with cabin air;
determining a second heat transfer rate to or from the surface based on a second temperature applied thereto, the second temperature being associated with a material layer;
estimating a temperature of the surface based on the first heat transfer rate and the second heat transfer rate;
obtaining a setpoint temperature; and
comparing the setpoint temperature to the estimated temperature of the surface.

2. The method according to claim 1, wherein the method further comprises determining a third heat transfer rate to or from the surface based on a third temperature applied thereto, the third temperature being associated with an occupant; wherein the estimated temperature of the surface is further based on the third heat transfer rate.

3. The method according to claim 2, wherein the method further comprises determining a fourth heat transfer rate to or from the surface based on a fourth temperature applied thereto, the fourth temperature being associated with thermal radiation; wherein the estimated temperature of the surface is further based on the fourth heat transfer rate.

4. The method according to claim 3, wherein the method further comprises determining an occupancy status; wherein if the surface is occupied, at least the first and third heat transfer rates are employed to estimate the temperature of the surface; wherein if the surface is unoccupied, at least the first heat transfer rate is employed to estimate the temperature of the surface; and wherein the occupancy status determines the magnitude of an effect of the thermal radiation.

5. The method according to claim 4, wherein the estimated temperature of the surface is predictive of the effect of the first, second, third, or fourth heat transfer rates, or any combination thereof, on the surface during a time of a program cycle.

6. The method according to claim 5, wherein the estimated temperature of the surface is further based on the setpoint temperature at steady state.

7. The method according to claim 6, wherein at or around the setpoint temperature, at least one thermal effector is not operational and/or the temperature of the surface is estimated without consideration of a heat transfer rate relative to the at least one thermal effector.

8. The method according to claim 7, wherein the setpoint temperature is selected by the occupant and/or an autonomous conditioning system; and wherein the setpoint temperature is received by a human-machine interface from the occupant.

9. The method according to claim 8, wherein at least one thermal effector influences heating or cooling of the surface.

10. The method according to claim 9, wherein if the estimated temperature of the surface is generally equal to the setpoint temperature, an operation mode of the at least one thermal effector is set to OFF.

11. The method according to claim 10, wherein if the estimated temperature of the surface is less than the setpoint temperature, the at least one thermal effector operates in a heating mode.

12. The method according to claim 11, wherein if the estimated temperature of the surface is greater than the setpoint temperature, the at least one thermal effector operates in a cooling mode.

13. The method according to claim 12, wherein the method further comprises controlling the at least one thermal effector by regulating power to the thermal effector and/or controlling a speed of a blower to achieve the setpoint temperature.

14. A system for performing the method of claim 1, the system comprising:
a surface, and
at least one thermal effector thermally influencing the surface.

15. The system according to claim 14, wherein the surface is on a vehicle component; wherein the vehicle component includes a steering wheel, a gear shifter, a seat, a headrest, a door panel, an instrument panel, a headliner, a center console, a leg panel, a floor, or any combination thereof.

16. The system according to claim 15, wherein the at least one thermal effector includes two or more thermal effectors that cooperate in thermally influencing the surface.

17. The system according to claim 16, wherein the thermal effector includes a resistance element, a thermoelectric device, or both.

18. The system according to claim 17, wherein the at least one thermal effector conductively thermally communicates with the surface.

19. The system according to claim 17, wherein the at least one thermal effector acts upon an airstream that convectively thermally communicates with the surface or convectively thermally communicates with an element that conductively communicates with the surface.

20. The system according to claim 19, wherein the system further comprises a containment device located within the vehicle component; and wherein the airstream flows into the containment device.

21. (canceled)
